(19) United States
(12) Patent Application Publication
(10) Pub. No.: US 2015/0136750 A1
(43) Pub. Date: May 21, 2015

(54) VEHICLE WINDSCREEN WIPER HEATING ELEMENT

(71) Applicant: Valeo Systèmes d'Essuyage, Le Mesnil Saint Denis (FR)

(72) Inventors: Gérald Caillot, Cernay La Ville (FR); Vincent Izabel, Chilly Mazarin (FR); Jean-Michel Jarasson, Le Mesnil Saint Denis (FR)

(21) Appl. No.: 14/548,820

(22) Filed: Nov. 20, 2014

(30) Foreign Application Priority Data
Nov. 21, 2013 (FR) 1361491

(51) Int. Cl. B60S 1/38

(52) U.S. Cl. CPC B60S 1/3805
USPC 219/202; 15/250.06; 219/541

(57) ABSTRACT

A windscreen wiper heating element for motor vehicle is disclosed. The heating element includes a circuit having a heating electrical conductor and a support of that circuit. The circuit includes a first loop, the ends of which are connected to electrical power supply terminals, and at least one second loop, the ends of which are connected to said terminals and the length and/or the section of the conductor of this loop is different from that or those of the conductor of the first loop.

### TECHNICAL FIELD

The present invention concerns a windscreen wiper heating element for a vehicle, in particular a motor vehicle, a vehicle windscreen wiper including that element, and a method of heating a vehicle windscreen wiper.

### PRIOR ART

It is known to heat a motor vehicle windscreen wiper, in particular in order to de-ice it in winter. When this wiper is equipped with internal windscreen washing liquid circulation passages, heating the wiper also enables the liquid to be heated before it is sprayed onto the windscreen of the vehicle, which facilitates de-icing the windscreen and can therefore avoid the use of a manual ice scraper.

A windscreen wiper of the “flat wiper” type typically includes a longitudinal body bearing a wiper blade, generally made of rubber, intended to rub against the windscreen of the vehicle to evacuate water and remove it from the field of view of the driver. The wiper further includes at least one longitudinal vertebra which imparts a curvature to the wiper blade, so as to improve the application of this blade to the windscreen. The wiper is carried by an arm that is driven by a motor in an angular to-and-fro movement. The means connecting the wiper to the arm generally include a connector that is fastened to the body and an adapter that is articulated to the body and fixed to one end of the arm.

In the current state of the art, the windscreen wiper heating means generally include a heating electrical conductor.

It has already been proposed to equip the vertebra for imparting a curvature to a wiper with heating means taking the form of a film that is applied to and stuck to the vertebra and includes a circuit or a track consisting of a heating electrical conductor. In the current state of the art, the conductor of the circuit forms a loop the ends of which are connected to electrical power supply terminals.

This technology has a serious disadvantage, however. In fact, if the conductor of the circuit is cut at any point, the loop becomes an open loop. The current can then no longer flow in the loop and the heating means are therefore no longer operative. The only solution is therefore to replace the wiper with a new one. Another disadvantage of this technology is linked to the fact that the power dissipated by the circuit is substantially the same over the whole of the length of the wiper although the upper portion of the wiper, i.e. the portion of the wiper extending beyond the driving arm (when the wiper is in the rest or stowed position), may be more exposed to cold and should therefore be heated more. It is equally feasible that it is the lower portion of the wiper (in particular in the case of a passenger-side wiper) that is more exposed to cold and must therefore be heated more.

The invention proposes a simple, effective and economical solution to these disadvantages of the prior art.

### SUMMARY OF THE INVENTION

The invention proposes a windscreen wiper heating element for a vehicle, in particular a motor vehicle, including a circuit consisting of a heating electrical conductor and a support of that circuit, the circuit including a first loop the ends of which are connected to electrical power supply terminals, characterized in that the circuit includes at least one other loop the ends of which are connected to said terminals and the length and/or the section of the conductor of this loop is different from that or those of the conductor of the first loop.

According to the invention, the circuit of the heating element includes two independent loops that are supplied with power via the same electrical terminals. Accordingly, if one of the loops is defective (for example because its conductor is cut), the other loop can continue to function, which is advantageous. Moreover, the loops of the heating element are different because their respective conductors are not the same. These conductors may differ from each other in terms of their length and/or their section.

It is known that the resistance of an electrical conductor is given by the formula: R=ρ.L/S (in which ρ is the resistivity, L the length and S the section) and that the power dissipated by the Joule effect is given by the formula P=R.I². This dissipated power can therefore be expressed as follows: P=ρL/S.I². It is therefore clear that increasing the length of a conductor leads to an increase in the power dissipated by it and that increasing its section leads to a decrease in the power dissipated.

The support of the circuit preferably has an elongate shape and preferably includes a substantially plane longitudinal surface. The terminals may be situated on this surface and at a distance from the longitudinal ends of the support.

The terminals are advantageously situated in a substantially median area of the support, which extends 30% to 70% (preferably 45% to 65% and more preferably 50% to 60%) of its length, for example, as measured from one of its longitudinal ends.

The first loop preferably extends from the terminals toward one of the longitudinal ends of the support and the second loop preferably extends from the terminals toward the opposite end of the support.

It is thus clear that the loops extend over two different longitudinal portions of the support (positioned substantially end-to-end) and are separated from each other by the electrical terminals. Thus a first loop enables heating of a first longitudinal portion of the support and the second loop enables heating of the second longitudinal portion of the support. Given the foregoing disclosure, it is equally clear that the conductors of the two loops are different from each other and that the power dissipated by the Joule effect in one of the longitudinal portions of the support will be different from that dissipated in the other longitudinal portion of the support.

At least one of the loops may have a U or W general shape, for example. At least one of the loops may include undulations.

The support of the heating element is preferably a vertebra for imparting a curvature to the windscreen wiper.

The present invention also concerns a windscreen wiper for a vehicle, in particular a motor vehicle, including a heating element as described above. The heating element preferably forms a curvature-imparting vertebra.

The wiper may include means for connection to a driving arm of the wiper. These connection means may include means of electrical connection to the terminals of the circuit of the heating element.

The connection means are advantageously situated between upper and lower longitudinal portions of the wiper, the first loop of the circuit of the heating element extending along a first of these longitudinal portions and the other loop of this circuit extending along the other of these longitudinal portions.

The conductor of the loop situated in the lower (respectively higher) longitudinal portion of the wiper, which is intended to extend at least in part along (respectively beyond) the driving arm, is preferably configured so that the power dissipated by the Joule effect in this lower (respectively higher) portion is less than that dissipated in the higher (respectively lower) portion of the wiper.

In other words, the lower portion of the wiper (which extends along the arm when the wiper is in the rest or stowed position) is heated less than the upper portion of the wiper (which extends beyond the arm). This upper portion may in fact be more exposed to inclement weather and to wind and is more sensitive to icing than the lower portion of the wiper, which is protected by the arm. Alternatively, the lower portion of the wiper (which extends along the arm when the wiper is in the rest or stowed position) is heated more than the upper portion of the wiper (which extends beyond the arm).

The present invention also concerns a method of heating a windscreen wiper of a vehicle, in particular a motor vehicle, this wiper including two longitudinal portions disposed substantially end-to-end and respectively heated by two loops of the same circuit consisting of a heating electrical conductor, in which method the power dissipated by the Joule effect by one of these loops is greater than that dissipated by the other loop.

The longitudinal portion of the wiper in which less power is dissipated is preferably the lower (respectively higher) portion of the wiper, i.e. the portion of the wiper intended to extend at least in part along (respectively beyond) its driving arm.

### DESCRIPTION OF THE FIGURES

The invention will be better understood and other details, features and advantages of the invention will become apparent on reading the following description given by way of nonlimiting example and with reference to the appended drawings, in which:

FIG. 1 is an exploded perspective view of a motor vehicle windscreen wiper,

FIG. 2 is a diagrammatic view of a heating element in accordance with the invention, and

FIG. 3 is a diagrammatic view of a variant embodiment of a heating element in accordance with the invention.

### DETAILED DESCRIPTION

It should be noted that the figures show the invention in detail for the purposes of implementing the invention, said figures being of course also usable to define the invention more clearly if necessary.

In the following description, the terms longitudinal and lateral refer to the orientation of the windscreen wiper in accordance with the invention. The longitudinal direction corresponds to the principal axis of the wiper along which it extends, while the lateral orientations correspond to straight line segments that are concurrent with, i.e. that cross, the longitudinal direction, notably perpendicularly to the longitudinal axis of the wiper in its plane of rotation. For the longitudinal directions, the terms upper and lower refer to the point of fixing the wiper to the wiper arm, the term interior corresponding to the portion in which the arm and one half-wiper extend.

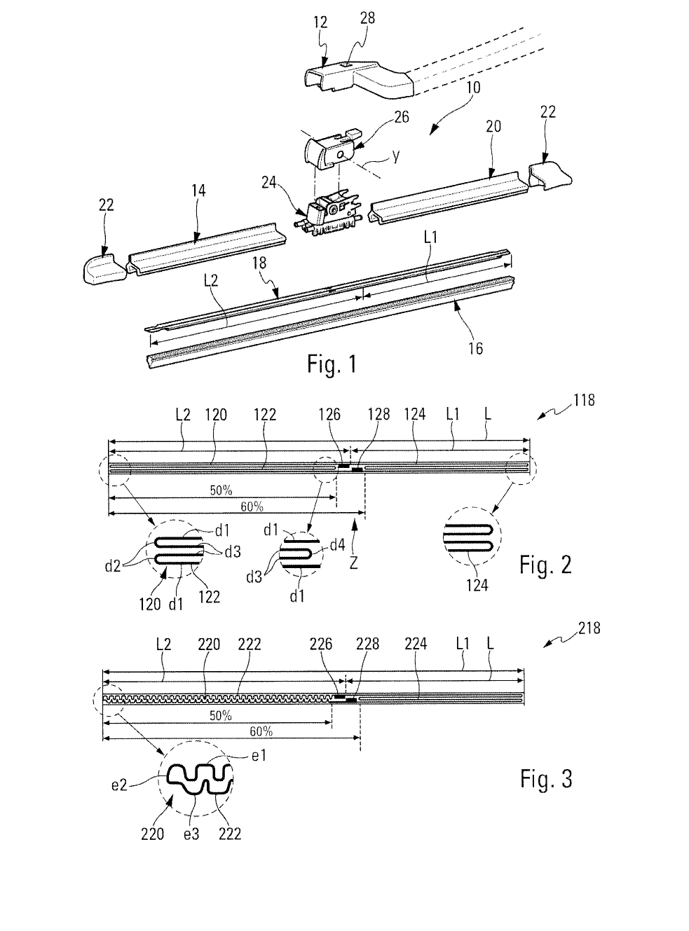

FIG. 1 shows a windscreen wiper 10 for a motor vehicle windscreen and an arm 12 for driving this wiper 10, this arm 12 being partially represented and intended to be driven by a motor so that the wiper follows an angular to-and-fro movement to evacuate water and possibly other unwanted elements covering the windscreen.

Here the wiper 10 includes a longitudinal body 14, a wiper blade 16, generally made of rubber, and at least one vertebra 18 that imparts a curvature to the blade 16 so as to improve the application of this blade to the windscreen.

The body 14 of the wiper 10 includes an upper deflector 20 intended to improve the functioning of the wiper, the object of this deflector 20 being to strengthen the pressing of the wiper onto the windscreen and thus improve the aerodynamic performance of the system.

The wiper 10 further includes end-pieces or clips 22 for attaching the blade 16 and the vertebra 18 to the body, these clips 22 being situated at each of the longitudinal ends of the body 14.

The body 14 of the wiper is produced here as two independent parts that are disposed substantially end-to-end and connected to each other by an intermediate connector 24.

For mounting it on the arm 12, the wiper 10 includes an adapter 26 mounted on the connector 24 and enabling articulation of the wiper 10 relative to the arm 12. The articulation of the wiper 10 relative to the arm 12 is an articulation in movement in rotation about a rotation axis Y perpendicular to the longitudinal axis of the wiper 10. The wiper 10 must in fact have at least one degree of freedom in rotation relative to the arm 12, and to be more specific relative to an end part 28 of the arm 12, to enable the wiper 10 to follow the curvature of the windscreen.

The invention concerns a windscreen wiper of the type including a heating element, this heating element including a circuit or a track consisting of a heating electrical conductor and a support of this circuit.

In accordance with one embodiment of the invention, the support is a vertebra for imparting a curvature to the windscreen wiper. A typical curvature-imparting vertebra is made of metal and has an elongate shape. A vertebra generally has a section of substantially rectangular shape and substantially parallel plane upper and lower surfaces.

FIGS. 2 and 3 represent two variant embodiments of the invention. Each of these figures shows a vertebra 118, 218 one of the aforementioned plane surfaces of which is covered by a circuit 120, 220 consisting of a heating electrical conductor. The conductor of the loops is made of stainless steel, for example, or an alloy based on copper, nickel, aluminium, etc. (copper alloy, brass, etc.). In accordance with the invention, this circuit 120, 220 includes at least two loops 122, 124 (FIG. 2), 222, 224 (FIG. 3) and two terminals 126, 128 (FIG. 2), 226, 228 (FIG. 3) for supplying electrical power to these loops. To this end, the two ends of each loop 122, 124, 222, 224 are connected to the respective two terminals 126, 128, 226, 228. To be more precise, the positive terminal 126, 226 is connected to a first end of each loop 122, 124, 222, 224 and the negative terminal 128, 228 is connected to the opposite end of each loop.

As seen in FIGS. 2 and 3, the vertebra 118, 218 has a length L and the terminals 126, 128, 226, 228 are situated at a distance from the longitudinal ends of the vertebra and in a substantially middle area Z of this vertebra. Here these terminals are situated in an area Z extending between approximately 50% and 60% of the length of the vertebra, as measured from a longitudinal end thereof (and thus between approximately 40% and 50% as measured from the opposite end of the vertebra).

This area Z may correspond to the position on the vertebra 118, 218 of the connector of the windscreen wiper. In fact, the connector may include electrical connection means intended to come into contact with the terminals 126, 128, 226, 228 of the circuit of the vertebra in the mounted position. Alternatively, the connector may be centred on the vertebra while the electrical connection between the terminals and the connection means is off-centre (for example for reasons of overall size).

The loop 122, 222 extends over a first longitudinal portion of length L1 of the vertebra 118, 228 between the terminals and the free end of this longitudinal portion. The loop 124, 224 extends over the second longitudinal portion of length L2 of the vertebra 118, 228 between the terminals and the free end of this longitudinal portion.

Here the loops 122, 124 and 224 are W-shaped and comprise two straight line segments dl along and parallel to respective longitudinal edges of the vertebra, these line segments dl having first ends that are respectively connected to the terminals 126, 128, 226, 228 and opposite ends d2 that are bent and respectively connected to first ends of two straight line segments d3 extending between the aforementioned straight line segments d1. The opposite ends d4 of these straight line segments d3 are joined together and substantially form a U.

It is seen in FIG. 3 that the loop 222 has a different shape and includes undulations. To be more precise, the loop 222 includes a first undulating line e1 along a longitudinal edge of the vertebra and one end of which is connected to the terminal 226, the opposite end e2 of this line el being bent and respectively connected to a first end of another undulating line e3 along the other longitudinal edge of the vertebra and the opposite end of which is connected to the terminal 228.

Alternatively, the loops could include a multitude of straight and parallel lines of conductor connected to one another in series. Each loop could for example be of the WWW type, including a plurality of successive W-shaped portions.

According to another feature of the invention, the loops of the vertebra 118, 218 are different and are configured so that the powers dissipated in the two longitudinal portions of the vertebra are different. To this end, the length and/or the section of the conductor of the loop 122, 222 is different from that or those of the conductor of the other loop 124, 224.

In the FIG. 2 example, the length of the conductor of the loop 124 is shorter than that of the conductor of the loop 122 and the section of the conductor of the loop 124 is smaller than that of the conductor of the loop 122 (this latter feature being diagrammatically represented in FIG. 2 by a loop 124 in which the lines representing the conductor are thinner than those of the loop 122).

In the FIG. 3 example, the length of the conductor of the loop 224 is shorter than that of the conductor of the loop 222 and the section of the conductor of the loop 224 is shorter than that of the conductor of the loop 122.

When the conductor has a section of circular shape, the section of this conductor may be modified by varying its diameter. When the conductor has a section of substantially rectangular plane shape, the section of this conductor may be modified by varying its width and/or its height (or its thickness, which is for example a few tenths).

As explained above, it is known that the power dissipated by the Joule effect by an electrical conductor is proportional to its length and inversely proportional to its section. Here the loops 122 and 222 of the vertebrae 118, 228 are configured to dissipate more power than the loops 124 and 224.

For the power dissipated in a first longitudinal portion of a vertebra to be greater than that dissipated in the second longitudinal portion of that vertebra, it is therefore necessary:
when the longitudinal portions are substantially the same length (centred area Z), that (i) the length of the conductor in the first portion is greater than that in the second portion (by virtue of undulations as in FIG. 3, for example, or a plurality of parallel lines of conductor as described above), if these conductors are of substantially the same type and section, or (ii) the section of the conductor of the first portion is less than that of the second portion, if these conductors are of the same type and length;
when one of the portions has a greater length than the other portion (off-centre area Z), to optimize the section and length parameters of the conductors of these portions to achieve the required aim.

In accordance with a preferred embodiment of a windscreen wiper in accordance with the invention, the longitudinal portion of length L1 of the vertebra, i.e. the longitudinal portion of the vertebra including the loop 124, 224 intended to dissipate less power, is that which is intended to lie in the vicinity of the driving arm of the wiper when the latter is in the rest or stowed position. This portion of length L1 of the vertebra is part of the lower portion of the wiper. This relative position of the portion of length L1 of the vertebra and the driving arm of the wiper is represented diagrammatically in FIG. 1 in which the portion of the arm 12 extending along the portion of the vertebra 18 of length L1 in the rest position is diagrammatically represented in dashed line.

Thus it is in the upper portion of the wiper that the loop 122, 222 that is intended to dissipate more power lies. This is particularly advantageous because this upper portion is the portion of the wiper most exposed to cold and to inclement weather in use because the lower portion of the wiper is more protected from cold and from inclement weather by the arm.

Alternatively, it is in the lower portion of the wiper that more power is intended to be dissipated.

1. A windscreen wiper heating element for a motor vehicle, comprising:
a circuit having a heating electrical conductor; and
a support of the circuit,
the circuit comprising a first loop the ends of which are connected to electrical power supply terminals, and at least one second loop the ends of which are connected to said power supply terminals, wherein the length and/or the section of the heating electrical conductor of the second loop is different from those of the heating electrical conductor of the first loop.

2. The heating element according to claim 1, wherein the support has an elongate shape and includes a substantially plane longitudinal surface, said terminals being situated on the plane longitudinal surface and at a distance from longitudinal ends of the support.

3. The heating element according to claim 2, wherein the terminals are situated in a substantially median area of the support which extends 30% to 70% of its length, as measured from one of the longitudinal ends of the support.

4. The heating element according to claim 2, wherein the first loop extends from the terminals toward one of the longitudinal ends of the support and the second loop extends from the terminals toward an opposite longitudinal end of the support.

5. The heating element according to claim 1, wherein at least one of the first and second loops has a U or W general shape.

6. The heating element according to claim 1, wherein at least one of the loops includes undulations.

7. The heating element according to claim 1, wherein the support is a vertebra for imparting a curvature to the windscreen wiper.

8. A windscreen wiper for a vehicle, in particular a motor vehicle, including a heating element according to claim 1.

9. The windscreen wiper according to claim 8, wherein the heating element forms a curvature-imparting vertebra.

10. The windscreen wiper according to claim 8, further comprising means for connection to a driving arm of the wiper, the connection means comprising means of electrical connection to the terminals of the circuit of the heating element.

11. The windscreen wiper according to claim 10, wherein the connection means are situated between upper and lower longitudinal portions of the wiper, the first loop of the circuit of the heating element extending along a first of these longitudinal portions and the other loop of this circuit extending along the other of these longitudinal portions.

12. The windscreen wiper according to claim 11, wherein the conductor of the loop situated in the lower longitudinal portion of the wiper, which is intended to extend at least in part along the driving arm, is configured so that the power dissipated by the Joule effect in this lower portion is less than that dissipated in the higher portion of the wiper.

13. A method of heating a windscreen wiper of a motor vehicle, the wiper comprising:
disposing two longitudinal portions substantially end-to-end and heating the two longitudinal portion by two respective loops of the same circuit of a heating electrical conductor, wherein power dissipated by the Joule effect by one of the two respective loops is greater than power dissipated by the other of the two respective loops.

14. The method according to claim 13, wherein the longitudinal portion of the wiper in which less power is dissipated is the lower portion of the wiper intended to extend at least in part along its an associated driving arm.
